(19) United States
(12) Patent Application Publication
(10) Pub. No.: US 2004/0259493 A1
(43) Pub. Date: Dec. 23, 2004

(54) Method and apparatus for negative pressure ventilation in vehicles

(76) Inventors: Charles Richard Valley, Beavercreek, OH (US); Daniel Edward Crichton, Valley Springs, CA (US)

Correspondence Address: HASSE GUTTAG & NESBITT LLC, 7550 CENTRAL PARK BLVD., MASON, OH, 45040, US

(21) Appl. No.: 10/862,700

(22) Filed: Jun. 7, 2004

Related U.S. Application Data
(60) Provisional application No. 60/479,874, filed on Jun. 20, 2003.

(51) Int. Cl. B60H 1/24

(52) U.S. Cl. 454/164

(57) ABSTRACT

A method and apparatus is provided for exhausting air from the interior of the occupant compartment of a movable vehicle to protect occupants from undesirable or contaminated air originating within or outside the vehicle. The method incorporates an exhaust system to remove air from the rear of the vehicle while maintaining air flow through the vehicle, preventing air back streaming, and sustaining a relative negative air pressure inside the occupant compartment. The invention prevents the breathing of air contaminated by people or animals being transported in vehicles and can protect occupants from diseases, odors, bio-hazards, and other undesirable or contaminated air in an enclosed compartment.

### CROSS REFERENCE TO RELATED APPLICATION

This application claims the benefit of co-pending U.S. Provisional Patent Application No. 60/479,874, filed Jun. 20, 2003.

### BACKGROUND OF THE INVENTION

When air becomes contaminated in critical environments, it is often withdrawn from the contaminated environment and exhausted to a non-critical environment. Examples of this occur in hospitals, clean rooms, manufacturing spaces and other similar environments where contaminated air is irritating or unpleasant to personnel or can pose a threat to personnel or to the execution of a process. In the case of hospitals it is common practice to ventilate contaminated air from the interior of hospital rooms using a system that creates a relative negative air pressure in the room preventing air in the enclosed space from exiting the room into the rest of the hospital. In many cases the air is exhausted to the outside of the hospital. In some cases this air is further treated to reduce or eliminate the contamination before it is exhausted to the outside of the hospital.

Air can be similarly withdrawn and exhausted from other environments. Often such systems are used to remove unpleasant smelling air or air containing chemicals from factory work areas or the inside of enclosed manufacturing work spaces, as in a clean room or even a general manufacturing facility.

Although these techniques are used extensively in fixed facilities, they are not commonly used in movable structures such as motor vehicles. In motor vehicles it is common to pressurize a passenger cabin by using a fan drawing air from the outside and exhausting it into the cabin. In late model vehicles manufacturers have recognized environmental risks, and the incoming air is often filtered by incoming air filters sometimes called cabin air filters. This is done to limit the introduction of particulate contaminants, biological contaminants, chemical contaminants, and odors. However, the filters only address trapping in-flowing contaminants, not contaminants or other undesirable air conditions arising within the confined space of a vehicle's interior.

When air is introduced through the air intake system of a vehicle, it is left to leak out through whatever air gaps are available rather than being actively exhausted. The air leaks out because the air intakes and blowers create a relatively higher air pressure inside the vehicle than the atmospheric pressure outside the vehicle. However, the process is inefficient in that the occupant compartments of most vehicles are intentionally sealed to help prevent unwanted noise in the passenger cabin and to prevent air leakage to the outside so that when the air is conditioned, as when it is heated or cooled, it is effective in providing comfort to the passengers in the vehicle.

In general, air inside these vehicles is trapped in the same way that it is in ordinary transportation vehicles such as private automobiles. The traveling air systems within vehicles are designed to allow pressurized cabin air introduced into the occupant compartment, also called occupant cabin, to leak out. In the case of police cars and other emergency vehicles, most of the time this arrangement works as designed. The interior cabin air usually can be maintained at a comfortable temperature, and air flow is sufficient to maintain the officer's overall comfort. However, when a police car is used to transport other individuals, policemen can find themselves in an enclosed space sharing the same breathing air often with a person whose health or other condition can be dangerous or not known. This can give rise to an unknown variety of exposures for the police officer from noxious odors through residual defensive sprays such as pepper spray to dangerous airborne pathogens. The police officers' alertness and even health can be at risk from exposure to these unknown agents.

As discussed above, most designs ventilate stale air, foul air, fumes or smoke from a vehicle by relying on only the introduction of air using the front blower and ducting typically positioned underneath the dashboard. Such ventilation systems have employed air scoops, dampers, and valves to control the incoming air. Often this type of ventilation system is called a “positive flow” ventilation system that generally introduces air into and about the interior and/or recirculates compartment air. Positive flow recirculated air ventilation systems can increase the threat posed by contaminated air by recirculating it and actually increasing the risk of breathing the contaminated air. Attempts have been made to reduce the health risk by including inline High Efficiency Particulate Air (HEPA) filters and ionization devices to counter the negative effects of recirculated mixed air within the occupant compartment of a vehicle. However, the mixing of air can allow some of the airborne pathogens to escape and spread throughout the interior of the vehicle.

Presently, there is no means commonly used to extract contaminated or other undesirable air from the inside of movable vehicles. Risks to emergency response workers exist inside of emergency response vehicles occupied by law enforcement, paramedic or other personnel confined in a vehicle with a person being transported. There is an occupational health risk of the transmission of infectious airborne pathogens exhaled by a detained, injured, or ill person to the officer or other emergency response worker.

It follows that a method is needed for extracting air from the region occupied by people being transported in an emergency vehicle without trapping the air inside the vehicle and without recirculating such trapped air with the incoming air in a manner that will cause recirculated and trapped air to be breathed by the vehicle attendants. In a broader sense a method for extracting any undesirable air from the interior of any movable vehicle is needed.

### BRIEF DESCRIPTION OF THE INVENTION

The invention relates to an apparatus for creating negative pressure in an occupant compartment of a movable vehicle comprising:

at least one air intake end for receiving air from the occupant compartment;

at least one air exhaust end for exhausting air removed from the occupant compartment;

at least one air driver for driving air through the apparatus to create a negative pressure in the occupant compartment; and

an air driver controller for effecting the operation of the air driver.

In another aspect the invention relates to a method for protecting personnel from contaminated air in an enclosed occupant compartment of a movable vehicle comprising:

drawing air from the occupant compartment;

forcing air from the occupant compartment to the exterior of the vehicle; and

forming a negative pressure zone within the occupant compartment.

### BRIEF DESCRIPTION OF THE DRAWINGS

FIG. 1 is a view of an installed apparatus according to one embodiment of the invention;

FIG. 2 is a view of an apparatus according to one embodiment of the invention;

FIG. 3 is a view of an apparatus according to one embodiment of the invention;

FIG. 4 is a view of a control panel for dash mounting according to one embodiment of the invention; and

FIG. 5 is a control circuit according to one embodiment of the invention.

### DETAILED DESCRIPTION OF THE INVENTION

The invention comprises a negative pressure ventilation system for emergency response, public transportation, prisoner transport, and other public and private vehicles to control the flow of, redirect, and expel airborne pathogen contaminated air or other noxious, contaminated, fouled, or undesirable air. The invention can be used to control airborne pathogen contaminated air, and/or noxious, contaminated, fouled, or other undesirable air in all passenger vehicles. Noxious, contaminated, fouled, or other undesirable air comprises but is not limited to air contaminated by pathogens, molds, fungi, allergens, odors, irritants, stimulants, depressants, hallucinogens, or air having other undesirable qualities. Negative pressure ventilation refers to creating a zone of air pressure that is lower than the atmospheric ambient pressure. In most cases, though not all cases, the enclosed passenger compartment of a vehicle is the negative pressure zone. When used in a vehicle, the invention can maintain a negative pressure zone in the passenger compartment by exhausting air from the passenger compartment. This is accomplished by providing a higher exhausting capacity of air from the compartment than the capacity of the vehicle vents and blowers to supply air into the compartment. A negative pressure relative to the ambient outside pressure is created within the passenger or occupant compartment. The negative pressure so developed is used to direct the flow of air from the compartment by locating air removal ducts so as to prevent air from any one part of the compartment from substantially back flowing or back streaming into the compartment and mixing with fresh air introduced into the compartment.

Air collected from the compartment is directed to the outside of the vehicle. In some cases the air being directed to the exterior of the vehicle can be further treated by filtering, ionization, heating, flaming or using other methods to render it benign to the atmosphere exterior to the vehicle. The invention can prevent occupants of the vehicle from being contaminated by air emanating from, in, on, or about other occupants of the vehicle. The invention can also be used to remove contaminated or non-contaminated air from the interior of a vehicle and enhance the rate of air exchange with air outside the vehicle.

To reduce the health risk of accidental inhalation of contaminated air within the occupant compartment of a vehicle, the invention can be used to create a safer environment wherein the air within a vehicle's occupant compartment can be directed rearward and quickly expelled from the occupant compartment while quickly replacing or exchanging the expelled air with clean, uncontaminated air introduced from outside the vehicle. In one embodiment the entire volume of air in the cabin of a Ford Crown Victoria police car is exchanged in about 26 seconds.

The invention can be adapted to fit various types of vehicles including police cruisers, passenger cars, SUVs, ambulances, taxi cabs, vans, busses and trucks.

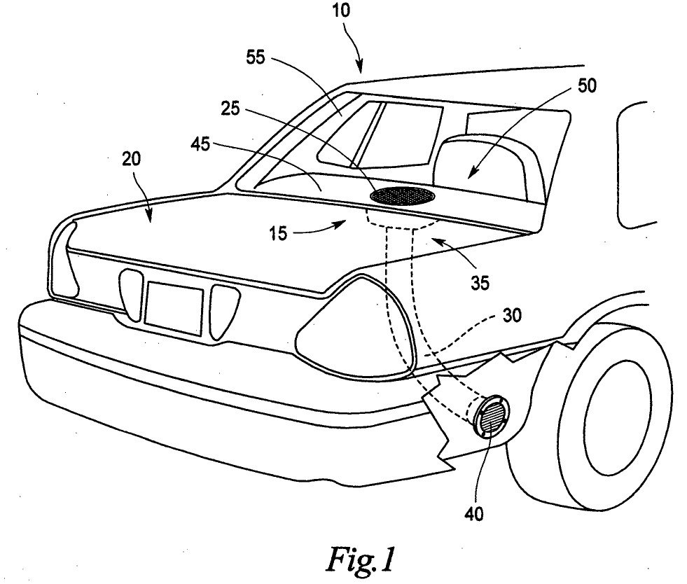

Referring to the drawings, FIG. 1 shows an embodiment of an installed negative pressure ventilation system 10. As shown in FIG. 1, the negative pressure ventilation system 15 is installed in an automobile's trunk 20. The drawing shows an air intake grille 25, air transfer conduit 30, exhaust fan motor assembly 35, and exit port 40. The air intake grille 25 for the negative pressure ventilation system 15 is mounted at the rear of the occupant compartment 50 of a vehicle, usually on a rear deck 45 in an automobile. From there, an exhaust fan motor assembly 35 and air transfer conduit 30 are mounted to the underside of the rear deck 45 adjacent the rear window 55. In this embodiment the exit port 40 can be mounted on the outer wall of a vehicle behind the rear bumper of the vehicle, or between the ear fender and the bumper, so as not to be easily seen from the outside of the vehicle.

The air moving capacity of the rear exhaust fan, fans or other air driver exceeds that of the front air intake blower, which creates negative pressure relative to ambient air pressure within the occupant compartment of the vehicle and directs any contaminated air toward the rear of the vehicle and away from the vehicle's occupants. The contaminated air is expelled through the air transfer conduit 30 and the exit port 40.

From another aspect the invention could be employed in a similar fashion in any vehicle with any enclosed compartment by suitably choosing a location for the air intake grille 25 to insure the air flow will effectively provide the conditions desired in the compartment.

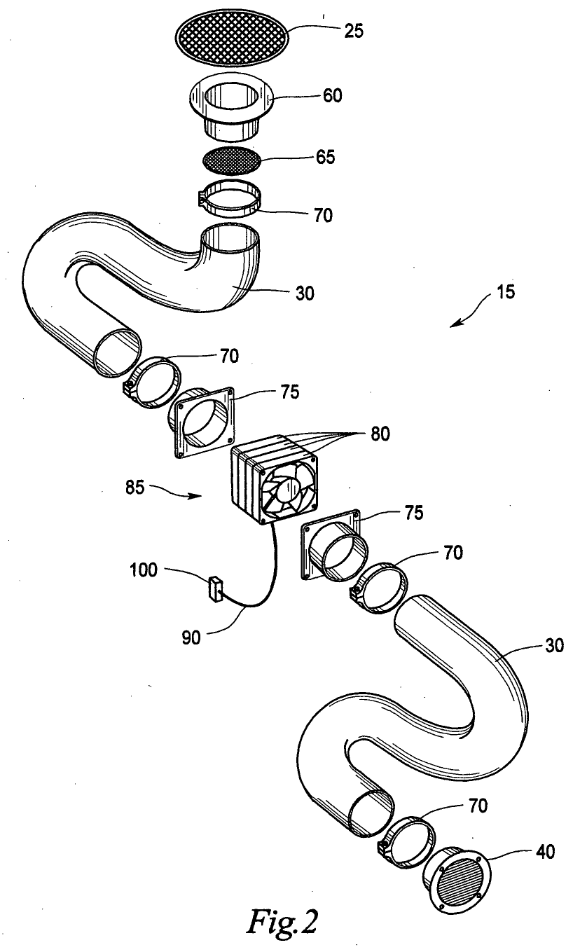

FIG. 2 is a drawing showing detail of one embodiment of a negative pressure ventilation system apparatus. In the embodiment shown, the negative pressure ventilation system 15 is comprised of an air intake grille 25, a grille to air transfer conduit transition element 60, an intake filter 65, air transfer conduits 30, component connecting devices 70, air transfer conduit to surface transition elements 75, stacked fans 85, and fan control lead 90. As shown, the negative pressure ventilation system 15 is equipped with a connector assembly 100 for attaching and communicating with the in-dash control unit.

As shown in FIG. 2 the unit features stacked fans 85. While a single fan 80 or a plurality of single fans 80 can be used, the stacked fans 85 shown are a redundant system. They comprise a plurality of individual fans 80 each mounted adjacent other fans 80 with their mounting frames in contact. Each individual fan 80 can be of different or the same capacity such that the overall stacked fans 85 provide the air moving capacity and characteristic required for the particular application. In the event one or more of the plurality of individual fans 80 in the stacked fans 85 becomes inoperable, another fan 80 or a plurality of individual fans 80 in the stack will maintain continuous exchange of air within the vehicle's occupant compartment. As shown in FIG. 2 four individual fans 80 are used to provide the stacked fans 85 stack. However, more or fewer fans can be used, and the particular design used will depend on the particular application. The fans 80 are chosen to provide a variety of air flow speeds depending on the needs of the particular application.

Embodiments can be developed using any of a wide variety, quantity, and configuration of available inlet blowers and exhaust fans 80, and air transfer conduits 30 such as plenums, air transfer tubes and air transfer conduit configurations using various diameters, shapes, capacities, and materials. For example, fans 80 with larger air flow capacities and larger diameter air transfer conduits 30 can be used for larger occupant compartments such as vans, trucks and busses, boats, and airplanes. Smaller capacity fans 80 and air transfer conduits 30 can be used as an operational system for an automobile or Sport Utility Vehicle (SUV). Similarly, air transfer conduit 30 lengths and diameters and associated hardware can vary depending on the length of the vehicle and the desired negative pressure. An anemometer can be used to measure the actual air suction that is indicative of a negative pressure. The measurement performed by the anemometer could then be fed into a control circuit to control the number of fans active and their speed of operation to maintain a desired negative pressure in the compartment.

The invention's components such as the fans 80 and air transfer conduits 30 can be integrated within the system to create the desired negative pressure within a vehicle's occupant compartment, sometimes called a passenger compartment. In all situations within a vehicle's occupant compartment, the invention creates negative air pressure by using an air driver to exhaust air that has a higher capacity than the comparatively smaller air volume being supplied by the vehicle's inlets and blowers. In larger vehicles with greater interior cabin air volume, a plurality of exhaust fans 80 and air transfer conduits 30 can be incorporated to create the necessary negative pressure environment within the occupant compartment

In another embodiment the plurality of fans 80 can be replaced with one or more other air drivers. For example the stacked fans 85 could be replaced with a compressor pump, a single fan 80, a connection to an engine turbocharger that pumps air from the compartment, an aspirator, or some other suitable air driver.

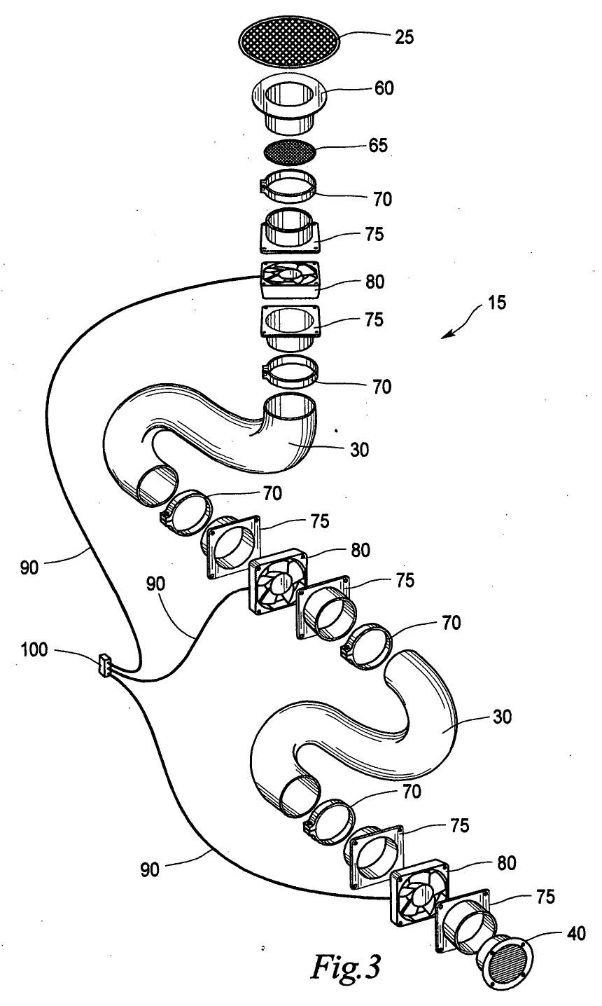

FIG. 3 shows another embodiment in which the air driver or plurality of devices such as individual fans 80 are distributed to provide air driving ventilation at a plurality of positions in the negative pressure ventilation system 15. Such a system provides redundancy and robustness of operation helping keep the system operable should one of the fans 80 become non-operational due to, for example, localized physical abuse or destruction or failure of one part of the system. This distribution of air drivers could be implemented for other reasons as well. For example, space constraints in a particular installation might require the air drivers to be separated and placed at different positions in the negative pressure ventilation system 15.

Optional features include filtering and ionization or a heat chamber to remove or destroy airborne pathogens or otherwise treat the exhaust air prior to expelling the air into the atmosphere. In addition the invention and its components can be mounted to existing surfaces within a vehicle, allowing installation to be relatively non-complex to one skilled in the art.

In one embodiment, upon activation, the invention continuously expels air away from the occupants within the vehicle's interior compartment through the creation of a negative pressure environment and by controlling the flow of air through the passenger compartment substantially preventing back streaming.

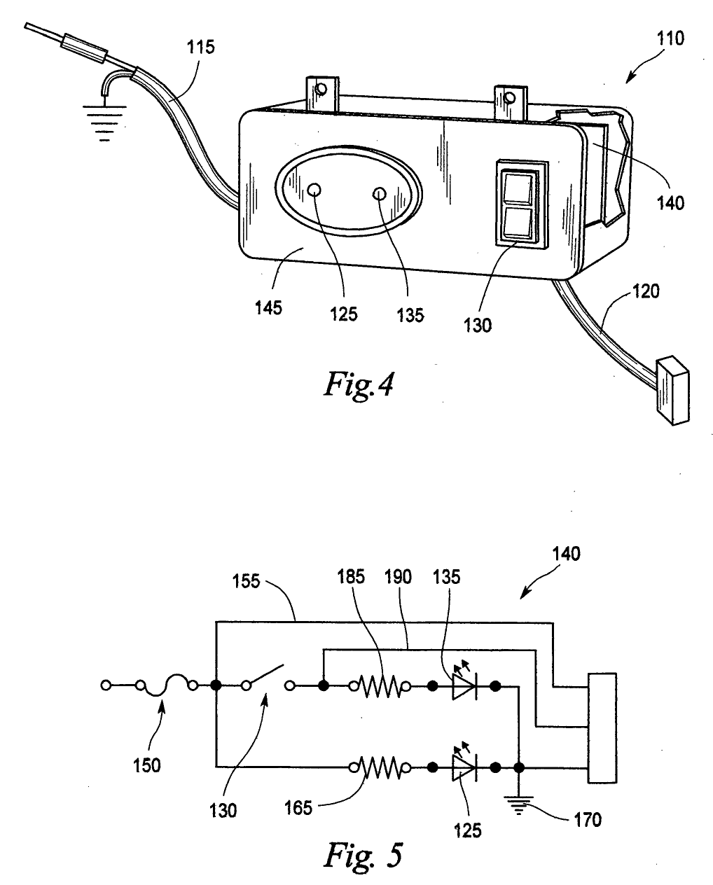

FIG. 4 shows a mountable controller 110 according to one embodiment. The mountable controller 110 receives power from the vehicle's battery through the battery lead 115 and delivers controlled power to the negative pressure ventilation system 15 through the power lead 120. In the embodiment shown the controller 110 can be mounted on the instrument panel of the vehicle and comprises two modes, a first mode, in one embodiment called a Whisper mode, indicated by a first mode light emitting diode 125, and a second mode, in one embodiment called a Turbo mode, indicated by a second mode light emitting diode 135. A light emitting diode is commonly referred to as an LED, and that convention will be used below. Because the first mode is quieter than the second mode and also of lower air moving capacity, in this embodiment the operator can switch between modes using a switch 130.

The first mode allows air to be expelled at lower volumetric rates, relative to the second mode. While in some embodiments the negative pressure ventilation system can be turned off using a switch similar to switch 130, in the embodiment shown at least one mode is on whenever the ignition switch is on.

Control of the fan 80 speed is accomplished by a circuit 140 communicatively in contact with the mountable controller 110. In FIG. 4 the control circuit 140 is mounted on the back of the mountable controller bezel 145.

Air can be driven through the system at different rates depending on which and how many fans 80 are switched on or off by the control circuit 140 in the different operating modes. If needed, fans 80 of various capacities can be used in the stacked fans 85. This adds a feature of redundancy and selectivity to operation. Also, the details of the control circuit 140 can vary from application to application. In any case operation causes foul or pathogen contaminated air to be continuously replaced with fresh air by actively drawing the undesirable air from the occupant compartment.

The second mode increases the rate of air expulsion to allow quicker replacement of foul or pathogen contaminated air. Both modes are operated by running the stacked fans 85 at higher volumetric rates than the rate at which air is supplied by the air supply vents and fans causing a relative negative pressure to be created in the passenger compartment as soon as the ignition key is turned on.

The fans 80 are chosen so that any one fan 80 of the stacked fans 85 can exhaust air from the vehicle at a higher volumetric rate than it is supplied by the vehicle's air intakes. This not only permits redundancy but operates as a safety feature to insure that air exhaust will remain continuous and effective in providing negative pressure ventilation.

FIG. 5 is an embodiment of the control circuit 140. When the vehicle ignition key is turned on, vehicle provided electrical power is applied to the vehicle's main circuit power fuse 150. The fuse is wired to the first mode fan elements' positive input 155 and the first mode LED 125 through the first mode load resistor 165 to ground 170 illuminating the first mode LED 125. In this embodiment these circuit elements are powered, and the first mode is operating, whenever the ignition is on.

When the switch 130 is closed, the power is similarly and in addition applied to the second mode LED 135 through the second mode load resistor 185 to ground 170 illuminating the second mode LED 135. When the switch 130 is closed, voltage is simultaneously applied through the second mode fan elements positive input 190 powering the second mode fans and increasing the exhaust capacity of the negative pressure ventilation system 15.

The circuit shown in FIG. 5 is only one embodiment of the possible control circuits. Those skilled in the art can provide a variety of control circuits providing a range of additional properties and features such as the active control mentioned above wherein an anemometer is used to sense the negative pressure in the compartment and adjust the operation of the air drivers accordingly. Such control circuits are routinely designed and fall under the scope of this invention.

In one embodiment the invention can be used for emergency response, public transportation, and prisoner transport vehicles to control the flow, redirect and expel airborne pathogen or mold spore and other allergen contaminated or foul air within the enclosed occupant compartment of the vehicle, away from law enforcement and paramedic personnel during transport of detained, ill, or injured persons who can be carriers of a contagious airborne transmitted disease. A small, confined enclosure as is characteristic of occupant compartments of emergency response and prisoner transport vehicles creates an environment conducive to transferring infectious antibiotic-resistant airborne microorganisms including but not limited to mycobacterium tuberculosis bacillus, meningococcal disease, Severe Acute Respiratory Syndrome (SARS), and various strains of influenza that risk health and psychological well being of exposed law enforcement, paramedic, and health care personnel.

From another aspect the health risk of cross-contamination among exposed incarcerated individuals, inmates, or injured persons during transport can be reduced by using the invention to suitably direct air flow out of the vehicle and away from these persons. The invention can comprise a plurality of air intakes with air intake grilles 25 to help provide individual protection by locating air intakes near each vehicle occupant.

Another embodiment benefits occupants from enhanced air exchange between the outside and inside of a vehicle to quickly remove undesirable air from the interior of a public or private vehicle when it has been left unattended or with the ignition in the off position. This can occur in situations such as when a vehicle has been sitting outside on a sunny day, and the air in the occupant compartment has become hot or odiferous needing to be quickly exchanged for passenger safety and/or comfort. Using a control circuit 140 as in FIG. 5, the ignition is simply turned on for the system to exhaust the undesirable air and replace it with fresh air. In this case, operation in the second mode will make the air exchange take place more rapidly.

In another embodiment the invention can help protect vehicle occupants when the vehicle has passed through a hazardous outside environment such as an environment containing a bio-threat. This is accomplished by increasing the rate at which air is passed through the passenger cabin of the vehicle preventing the build up of bio-hazard agents inside the vehicle.

From another aspect the invention minimizes the effects of mold spores and other allergens that blow in through the vehicle's standard ventilation system and tend to circulate within the cabin thereby creating an unacceptable air environment wherein the occupants are subjected to breathing these airborne pathogens, mold spores and allergens. The invention expels the contaminated air reducing allergen build-up and recirculation.

In another embodiment the invention can be used to control the flow of residual pepper spray vapors from incarcerated individuals or detainees away from law enforcement personnel, paramedic personnel, and/or police dogs within the emergency response or prisoner transport vehicle's occupant compartment.

Yet another aspect quickly removes foul air from a shared, confined seating area of emergency response vehicles including K-9 units or animal control vehicles when police dogs or captured animals have odors. The invention will allow the continuous exchange and flow of safe, fresh air to occupants within the occupant compartment of vehicles while continuously expelling contaminated air.

In another embodiment the invention reduces the fogging effect within the interior of the vehicle from humidity within the vehicle. This is accomplished efficiently and rapidly as the invention can be continuously operating whenever the ignition of the vehicle is in its on position and humid air from inside the vehicle is removed and replaced with fresh outside air.

The invention also provides a method for protecting personnel from contaminated air in an enclosed occupant compartment of a movable vehicle. Protection is accomplished by drawing air from the occupant compartment, and forcing the air from the occupant compartment to the outside of the vehicle as described above. In removing the air from the occupant compartment, a zone is created inside the occupant compartment in which the air pressure is lower than the ambient air pressure outside the vehicle. This negative pressure zone is formed by actively removing the compartment air using an air driver with a capacity to exhaust air from the compartment at a rate higher than can be supplied by the air blowers and air inlets of the vehicle. The air driver enhances the rate of air exchange with air outside the vehicle drawing fresh air into the occupant compartment and expelling air that has been in the vicinity or used by compartment occupants.

In one embodiment the air driver is placed in the compartment to direct air from the air blowers and inlets to the back of the compartment in a manner that substantially prevents the air from back streaming into the occupant compartment and prevents mixing old air with air newly introduced into the compartment by the blowers and air inlets. The method can be used to expel any air in the compartment deemed undesirable by vehicle occupants.

In one embodiment the method is particularly effective in protecting police officers from air emanating from other occupants of a police vehicle.

Those skilled in the art will realize that this invention is capable of embodiments different from those shown and described. It will be appreciated that the detail of the structure of this apparatus and methodology can be changed in various ways without departing from the scope of this invention. Accordingly, the drawings and detailed description of the embodiments are to be regarded as including such equivalents as do not depart from the scope of the invention.

We claim:

1. An apparatus for creating negative pressure in an occupant compartment of a movable vehicle comprising:
at least one air intake end for receiving air from the occupant compartment;
at least one air exhaust end for exhausting air removed from the occupant compartment;
at least one air driver for driving air through the apparatus to create a negative pressure in the occupant compartment; and
an air driver controller for effecting the operation of the air driver.

2. The apparatus of claim 1 further comprising at least one air transfer conduit for channeling air from the air intake end to the air exhaust end of the apparatus.

3. The apparatus of claim 1 wherein the air driver is a fan.

4. The apparatus of claim 1 wherein the air driver is a plurality of fans.

5. The apparatus of claim 1 wherein the air driver is stacked fans.

6. The apparatus of claim 1 wherein the apparatus is used to direct air within the occupant compartment of a vehicle rearward and expel the air to outside the vehicle.

7. The apparatus of claim 1 wherein the apparatus is used to protect emergency response personnel from contaminated air originating from people being served by an emergency response vehicle.

8. The apparatus of claim 1 wherein the air intake location of the apparatus prevents the air from substantially back flowing into the occupant compartment and mixing with fresh air introduced into the compartment.

9. The apparatus of claim 1 wherein the apparatus is used to protect police officers from breathing contaminated air originating from transportees in police cars.

10. The apparatus of claim 1 wherein the apparatus is used to increase flow of fresh air into the occupant compartment of the vehicle.

11. The apparatus of claim 1 wherein the apparatus is used to ventilate air deemed undesirable by occupants from the inside of the vehicle.

12. The apparatus of claim 1 wherein the air moving capacity of the air driver exceeds the volume of fresh air from the air intakes of the vehicle.

13. The apparatus of claim 1 wherein the air can be driven at varying rates by controlling operation of the air driver.

14. The apparatus of claim 1 further comprising a system for purifying the contaminated air before releasing it outside the vehicle.

15. The apparatus of claim 1 further comprising a system for filtering air before it passes through the air driver.

16. The apparatus of claim 1 wherein the exhaust end of the apparatus is placed on the outer wall of the vehicle body behind the bumper of the vehicle.

17. The apparatus of claim 1 wherein the negative pressure can be created in any compartment of a movable vehicle.

18. A method for protecting personnel from contaminated air in an enclosed occupant compartment of a movable vehicle comprising:
drawing air from the occupant compartment;
forcing air from the occupant compartment to the exterior of the vehicle; and
forming a negative pressure zone within the occupant compartment.

19. The method of claim 18 wherein air is directed through the occupant compartment from front to back without permitting it to substantially back stream into the occupant compartment from the back of the occupant compartment.

20. The method of claim 18 wherein police officers are protected from air emanating from other occupants of a police vehicle.

21. The method of claim 18 wherein air from the interior of a vehicle is exhausted by enhancing the rate of air exchange with air outside the vehicle.

22. The method of claim 18 wherein contaminated air includes any air deemed undesirable by vehicle occupants.
